(19) United States
(12) Patent Application Publication
(10) Pub. No.: US 2020/0129917 A1
(43) Pub. Date: Apr. 30, 2020

(54) COLUMN FOR CARRYING OUT MASS EXCHANGE PROCESSES, IN PARTICULAR DESORPTION AND ABSORPTION PROCESSES, MASS EXCHANGE APPARATUS WITH THE SAME AND METHOD FOR EXTRACTING IODINE FROM DRILLING AND/OR FORMATION WATER OF OIL OR GAS FIELDS BY AIR

(71) Applicants: Serguei TIKHONOV, (US); Lia NEUMANN, (US)

(72) Inventors: Serguei TIKHONOV, Bremen (DE); Lia NEUMANN, The Woodlands, TX (US); Yusub ISHANGULYYEV, Ashgabat (TM)

(21) Appl. No.: 16/662,482

(22) Filed: Oct. 24, 2019

(51) Int. Cl. B01D 53/14

(52) U.S. Cl. CPC B01D 53/1487; B01D 2221/04; B01D 2257/2068

(57) ABSTRACT

Column for carrying out mass exchange processes, in particular desorption and absorption processes, said column comprising: a vertical cylindrical container comprising a first cylindrical container section having a first height hi and a first diameter d1, a second cylindrical container section having a second height h2 and a second diameter d2, a third cylindrical container section having a third height h3 and a third diameter d3 and a fourth cylindrical container section having a fourth height h4 and a fourth diameter d4 from bottom to top in a longitudinal direction of the container, a gas, in particular air, inlet in the wall of the first container section and a liquid outlet in the first container section, a polyethylene packing in each of the second container section and the third container section, a liquid inlet in the wall of the third container section, a liquid distributor that is placed in the third container section and is in fluid connection with the liquid inlet, and a gas mixture, in particular air mixture, outlet in the fourth container section, mass exchange apparatus comprising such a column, method for extracting iodine from drilling and/or formation water of oil or gas fields by air and use of such a column or mass exchange apparatus for extracting iodine from drilling and/or formation water of oil or gas fields by air.

The present invention relates to a column for carrying out mass exchange processes, in particular desorption and absorption processes, a mass exchange apparatus comprising such a column, a method for extracting iodine from drilling and/or formation water of oil or gas fields by air and the use of such a column or mass exchange apparatus. In particular, the present invention belongs to the field of development of equipment for mass exchange processes and can be used in various industries and, in particular, in the chemical and oil industries, to extract iodine from drilling and formation waters of oil and gas fields by air.

Currently, in the iodine-bromine industry of the CIS countries, titanium desorption columns with a height of 22-24 m and a height of a packing layer of 12-13 m are commonly used as mass exchange devices for the extraction of iodine from formation waters by air method. The degree of iodine extraction at the stage of air desorption does not exceed 85 to 90%. As a packing, these known desorption units use a two-stage screw polyethylene packing of 75×1000 mm in size. Hydrodynamic studies have shown that in this mode the liquid moves without vortexation. The phase contact time, which can be indirectly expressed through the time the fluid stays in the packing within this mode, decreases with increasing air velocity, as the retention capacity ratio of the packing to the amount of fluid flowing down per unit of time decreases. The total phase contact surface in this mode is reduced, because the liquid flows without vortexes, and the increase in its amount only increases the thickness of the flowing liquid film. The surface of the phase contact, which is referred to the unit of volume of flowing liquid, will decrease with the increase of the amount of liquid. Increasing the density of the fluid film slows down the speed of alignment of the concentration and temperature inside the fluid, which reduces the driving force of the process at the phase boundary.

The object of the invention is therefore to provide a column for carrying out mass exchange processes that enables a higher degree of iodine extraction.

The object is achieved by a column for carrying out mass exchange processes, in particular desorption and absorption processes, said column comprising:

a vertical cylindrical container comprising a first cylindrical container section having a first height h1 and a first diameter d1, a second cylindrical container section having a second height h2 and a second diameter d2, a third cylindrical container section having a third height h3 and a third diameter d3 and a fourth cylindrical container section having a fourth height h4 and a fourth diameter d4 from bottom to top in a longitudinal direction of the container,

a gas, in particular air, inlet in the wall of the first container section and a liquid outlet in the first container section,

a polyethylene packing in each of the second container section and the third container section,

a liquid inlet in the wall of the third container section,

a liquid distributor that is placed in the third container section and is in fluid connection with the liquid inlet, and

a gas mixture, in particular air mixture, outlet in the fourth container section.

Furthermore, this object is achieved by a mass exchange apparatus comprising a column according to any one of claims 1 to 9 and a high-pressure fan in fluid connection with the gas inlet of the column, preferably the high-pressure fan being made of steel or cast iron.

In addition, the object is achieved by a method for extracting iodine from drilling and/or formation water of oil or gas fields by air, in particular using the column according to any one of claims 1 to 9 or the mass exchange apparatus according to claim 10, comprising carrying out air desorption of iodine from drilling and/or formation water in a phase inversion mode or in a mode close to it.

Furthermore, the object is achieved by use of the column according to any one of claims 1 to 9 or the mass exchange apparatus according to claim 10 for extracting iodine from drilling and/or formation water of oil or gas fields by air, comprising operating the column in a phase inversion mode or in a mode close to it.

Preferably the height h of the container is in a range of 15 m to 16 m.

Advantageously, a total height of the packings is in a range of 5 m to 7 m.

According to a special embodiment, the first and fourth diameters are greater than the second and third diameters.

According to a further special embodiment, the second and third diameters are equal, in particular 3.1 m.

Preferably the first and fourth diameters are equal, in particular 3.6 m.

Conveniently, the column further comprises at least one packing support for supporting one of said packings.

Preferably the column further comprises at least one flow restricting element, in particular edge deflector.

According to a further special embodiment the column further comprises a mist catching packing in the fourth container section.

The invention recognizes that the mass transfer desorber (emulsifier) filled with highly-effective packing allows the column to operate in a mode close to the inversion phase (W_{g.}/W_{inv.}=0.8-0.85) to increase the degree of iodine extraction at the stage of air desorption. In particular, the column/apparatus allows to work effectively both in the phase inversion mode (close to overflow) and in the less intensive mode (W_{g.}/W_{inv.}=0.8-0.85).

For example, research data on air desorption of iodine from drilling iodine-containing water using a titanium column of 0.47 meter in diameter conducted in industrial conditions with the height of the packing layer of 3.2 meter showed that the rate of air desorption of iodine from drilling water in the phase inversion mode is 95-96%, which is 10 to 15 percent higher compared to the commonly used in the iodine industry mass exchangers with the height of the packing layer 12-13 m with the desorption rate of 85-90%.

Furthermore, compared to iodine industry devices used for iodine air desorption with the height of packing layer of =12-13 m, the packing layer in the emulsifiers according to the present invention does not exceed 5-7 m, so they are compact and the cost of the construction is 40 to 50% lower than of the column operating in the film mode.

For example, currently the processes of air desorption and iodine absorption are carried out using a vacuum system, where titanium is used as a material for production of the vacuum fan. Operation of the emulsifying mass exchange column/apparatus depends on the air injection into the mass exchange column/apparatus. Therefore preferably steel or cast iron is used as a material for manufacturing of the case and high-pressure fans, the cost of which is much lower than the cost of vacuum fans made of titanium.

Further features and advantages of the invention will become clear from the enclosed claims and the following description, in which a special embodiment of the invention is illustrated in detail with reference to the drawing, wherein the only FIGURE depicts a side view of a column for carrying out mass exchange processes according to a special embodiment of the present invention.

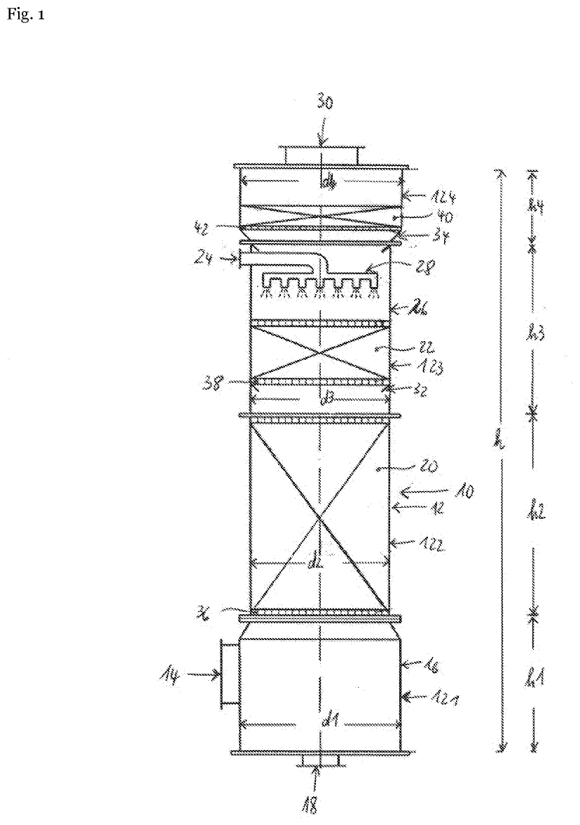

FIG. 1 shows the design of a column 10 for carrying out mass exchange processes according to a special embodiment of the present invention. In particular, said column is for air desorption of iodine from formation waters. Said column 10 comprises a vertical cylindrical container 12 comprising a first cylindrical container section 121 having a first height h1 and a first diameter d1 (except for a transition section), a second cylindrical container section 122 having a second height h2 and a second diameter d2, a third cylindrical container section 123 having a third height h3 and a third diameter d3 and a fourth cylindrical container section 124 having a fourth height h4 and a fourth diameter d4 (except for a transition section) from bottom to top in a longitudinal direction of the container 12. Furthermore, a column 10 comprises a gas, in this case air, inlet 14 in the wall 16 of the first container section 121 and a liquid outlet 18 at the bottom of the first container section 121, a polyethylene packing 20 and 22, respectively, supported by respective packing supports 36 and 38 in each of the second container section 122 and the third container section 123, a liquid inlet 24 for drilling and/or formation water in the wall 26 of the third container section 123, a liquid distributor 28 that is placed in the third container section 123 and is in fluid connection with the liquid inlet 24, and a gas mixture, in this case iodine-air mixture, outlet 30 in the fourth container section 124.

The height h of the container 12 is in a range of 15 m to 16 m. The total height of the packings 20 and 22 is in a range of 5 m to 7 m. The first and fourth diameters d1 and d4 are 3.6 m and the second and third diameters d2 and d3 are 3.1 m. Said diameters are chosen to reduce the rate of air supply to the lower and upper parts of the column (desorber). This allows a more even distribution of air at the bottom of the packings 20 and 22. Increasing the diameter of the column 10 in the fourth container section 124 reduces the linear velocity of the iodine-air mixture to for example 1.5-1.9 m/s and prevents the escape of formation water particles with the iodine-air mixture from a fourth container section 124 at the stage of iodine absorption.

Furthermore, for drawing the liquid (fluid) from the inner wall of the column 10 into the packings 20 and 22, edge deflectors 32 and 34 are installed along the height of the column 10.

The fourth container section 124 includes a mist catching packing 40 supported by a packing support 42.

At least one of the packings can be a grid, in particular a gridiron grid.

The features in the foregoing description, in the claims and/or in the accompanying drawings may, both and in any combination thereof, be material for realizing the invention in diverse forms thereof.

### REFERENCE SIGNS LIST

10 column
12 container
14 gas inlet
16 wall
18 liquid outlet
20, 22 packings
24 liquid inlet
26 wall
28 liquid distributor
30 outlet
32, 34 edge deflectors
36, 38 packaging support
40 mist catching packing
42 packing support
121 first container section
122 second container section
123 third container section
124 fourth container section
d1 first diameter
d2 second diameter
d3 third diameter
d4 fourth diameter
h1 first height
h2 second height
h3 third height
h4 fourth height

1. Column (10) for carrying out mass exchange processes, including desorption and absorption processes, said column comprising:
a vertical cylindrical container (12) comprising a first cylindrical container section (121) having a first height h1 and a first diameter d1, a second cylindrical container section (122) having a second height h2 and a second diameter d2, a third cylindrical container section (123) having a third height h3 and a third diameter d3 and a fourth cylindrical container section (124) having a fourth height h4 and a fourth diameter d4 from bottom to top in a longitudinal direction of the container,
a gas inlet (14) in the wall (16) of the first container section (121) and a liquid outlet (18) in the first container section (121),
a polyethylene packing (20, 22) in each of the second container (122) section and the third container section (123),
a liquid inlet (24) in the wall (26) of the third container section (123),
a liquid distributor (28) that is placed in the third container section (123) and is in fluid connection with the liquid inlet (24), and
a gas mixture outlet (30) in the fourth container section (124).

2. Column (10) according to claim 1, wherein the height h of the container (12) is in a range of 15 m to 16 m.

3. Column (10) according to claim 1, wherein the total height of the packings (20, 22) is in a range of 5 m to 7 m.

4. Column (10) according to claim 1, wherein the first and fourth diameters d1 and d4 are greater than the second and third diameters d2 and d3.

5. Column (10) according to claim 1, wherein the second and third diameters d2 and d3 are equal.

6. Column (10) according to claim 1, wherein the first and fourth diameters d1 and d4 are equal.

7. Column (10) according to claim 1, further comprising at least one packing support (36, 38) for supporting one of said packings (20, 22).

8. Column (10) according to claim 1, further comprising at least one flow restricting element.

9. Column (10) according to claim 1, further comprising a mist catching packing (40) in the fourth container section (124).

10. Mass exchange apparatus comprising a column (10) according to claim 1 and a high-pressure fan in fluid connection with the gas inlet (14) of the column (10).

11. Method for extracting iodine from drilling and/or formation water of oil or gas fields by air, using the mass exchange apparatus according to claim 10, comprising
carrying out air desorption of iodine from drilling and/or formation water in a phase inversion mode or in a mode close to it.

12. (canceled)

13. Method for extracting iodine from drilling and/or formation water of oil or gas fields by air, using the column (10) according to claim 1, comprising
carrying out air desorption of iodine from drilling and/or formation water in a phase inversion mode or in a mode close to it.
